(19) United States
(12) Patent Application Publication
(10) Pub. No.: US 2006/0143538 A1
(43) Pub. Date: Jun. 29, 2006

(54) Static timing analysis apparatus and method for distributed real-time embedded software

(76) Inventors: Yong Hoon Choi, Seoul (KR); Hyung Taek Lim, Daejeon (KR); Chae Deok Lim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/226,004

(22) Filed: Sep. 14, 2005

(30) Foreign Application Priority Data
Dec. 20, 2004 (KR) 2004-108906

(51) Int. Cl. G06F 11/00

(52) U.S. Cl. 714/38

(57) ABSTRACT

A static timing analysis apparatus and method for distributed real-time embedded software is provided. The static timing analysis apparatus includes: a task analyzer analyzing tasks per processor from a source code of real-time embedded software if the source code exists or a design model of a corresponding piece of the real-time embedded software if the source code does not exist; a message analyzer analyzing messages per network from the source code or the design model; a task worst-case response time analyzer analyzing a worst-case response time of each task, which is taken account of a scheduling policy of a corresponding operating system at which said each task is operated, based on the task analysis result for each processor and the message analysis result for each network; and a task real-time analyzer analyzing whether the analyzed worst-case response time of each task exceeds a deadline of the corresponding task.

### BACKGROUND OF THE INVENTION

1. Field of the Invention

The present invention relates to a static timing analysis apparatus and method for distributed real-time embedded software, and more particularly, to a static timing analysis apparatus and method for distributed real-time embedded software that statically analyzes finishing times of tasks operated in each processor and operability of the individual tasks in schedule of transmission times of messages transmitted through individual networks.

2. Description of the Related Art

Generally, a software response time measurement method is used to check whether distributed real-time embedded software can take its all tasks operate within their deadlines. Since the software response time measurement method is a dynamic analysis method in which the analysis is applied to those already implemented systems, reliability of the analysis is high and additional efforts for the analysis are not frequently required.

However, this dynamic analysis method cannot be applied before the embedded software is all implemented or in the middle of implementation, and the analysis result does not guarantee behavior of systems in all possible cases. That is, the software response time measurement method is appropriate for analyzing an average response time of the real-time embedded software, but inappropriate for analyzing a worst-case response time.

### SUMMARY OF THE INVENTION

Accordingly, the present invention is directed to a static timing analysis apparatus and method for distributed real-time embedded software, which substantially obviates one or more problems due to limitations and disadvantages of the related art.

It is an object of the present invention to provide a static timing analysis apparatus and method for distributed real-time embedded software that can be applied at the testing step and at the designing step prior to the testing step by obtaining necessary information for a real-time characteristic analysis based on a software design model in the case of no software implementation and analyzing whether a real-time requirement specification of the system is satisfied during a development of the distributed real-time embedded software.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a static timing analysis apparatus for distributed real-time embedded software, including: a task analyzer analyzing tasks per processor based on either a source code of real-time embedded software if the source code exists or a design model of a corresponding piece of the real-time embedded software if the source code does not exist; a message analyzer analyzing messages per network based on one of the source code and the design model; a task worst-case response time analyzer analyzing a worst-case response time of each task, which is taken account of a scheduling policy of a corresponding operating system at which said each task is operated, based on the task analysis result for each processor provided by the task analyzer and the message analysis result for each network provided by the message analyzer, and a task real-time analyzer analyzing whether the worst-case response time of each task analyzed by the task worst-case response time analyzer exceeds an execution deadline of the corresponding task.

In another aspect of the present invention, there is provided a static timing analysis method for distributed real-time embedded software, including the steps of: analyzing tasks per processor based on either a source code of real-time embedded software if the source code exists or a design model of a corresponding piece of the real-time embedded software if the source code does not exist; analyzing messages per network based on the source code and the design model, analyzing a worst-case response time of each task, which is taken account of a scheduling policy of a corresponding operating system at which said each task is operated, based on the task analysis result for each processor and the message analysis result for each network; and analyzing whether the analyzed worst-case response time of each task exceeds an execution deadline of the corresponding task.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a functional block diagram of a distributed real-time embedded software system in accordance with one embodiment of the present invention;

FIG. 2 illustrates a functional block diagram of a static timing analysis apparatus for distributed real-time embedded software in accordance with a specific embodiment of the present invention;

FIG. 3 illustrates a detailed functional block diagram of a task analysis unit illustrated in FIG. 2;

FIG. 4 illustrates a detailed functional block diagram of a message analysis unit illustrated in FIG. 2; and

FIG. 5 is a flowchart describing a static timing analysis method for distributed real-time embedded software in accordance with the specific embodiment of the present invention.

### DETAILED DESCRIPTION OF THE INVENTION

Reference will now be made in detail to the preferred embodiments of the present invention, examples of which are illustrated in the accompanying drawings.

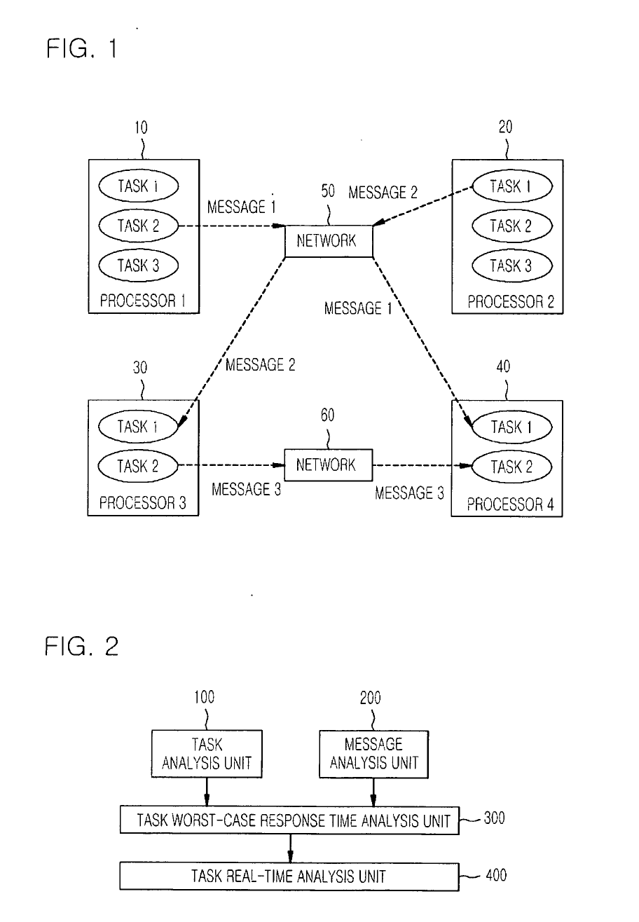

FIG. 1 is a functional block diagram illustrating processors and networks implemented with distributed real-time embedded software in accordance with one embodiment of the present invention.

As illustrated, the system implemented with the distributed real-time embedded software includes: a plurality of processors 10 to 40 and a plurality of networks 50 and 60.

In each of the processors 10 to 40, tasks are operated, and messages are transferred through the individual networks 50 and 60. Each of the tasks and messages has a deadline, and it is analyzed whether the tasks and messages can be appropriately operated within the deadline.

FIG. 2 is a functional block diagram illustrating a static timing analysis apparatus for distributed real-time embedded software in accordance with a specific embodiment of the present invention.

The static timing analysis apparatus includes: a task analysis unit 100; a message analysis unit 200; a task worst-case response time analysis unit 300; and a task real-time analysis unit 400. The task analysis unit 100 analyzes tasks per processor from a source code of the real-time embedded software if the source code exists, or from a design model of a corresponding piece of the real-time embedded software if the source code does not exist. The message analysis unit 200 analyzes messages per network from the source code of the real-time embedded software or from the design model of the corresponding piece of the real-time embedded software. On the basis of the task analysis result per processor provided from the task analysis unit 100 and the message analysis result per network provided from the message analysis unit 200, the task worst-case response time analysis unit 300 analyzes a worst-case response time of each task taken account of a scheduling policy of a corresponding operating system on which each task is operated. The task real-time analysis unit 400 analyzes whether the worst-case response time of each task analyzed by the task worst-case response time analysis unit 300 exceeds a deadline of the corresponding task.

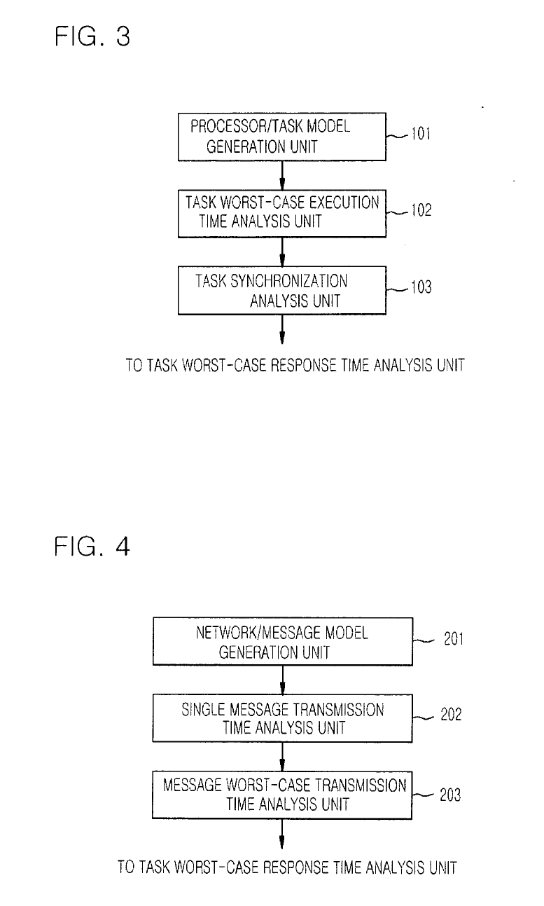

FIG. 3 is a detailed block diagram showing the embodied task analysis unit shown in FIG. 2.

The task analysis unit 100 includes: a processor/task model generation unit 101; a task worst-case execution time analysis unit 102; and a task synchronization analysis unit 103. The processor/task model generation unit 101 generates task models classified for each processor based on the source code of the real-time embedded software or the design model of the corresponding piece of the real-time embedded software. The task worst-case execution time analysis unit 102 analyzes a worst-case execution time for each task from the task models generated by the processor/task model generation unit 101. Based on the task models generated by the processor/ task model generation unit 101 and the worst-case execution time of the individual task analyzed by the task worst-case execution time analysis unit 102, the task synchronization analysis unit 103 analyzes a worst-case blocking time of each task caused by synchronization due to a common sharing of resources between the tasks.

FIG. 4 is a detailed block diagram showing the embodied message analysis unit illustrated in FIG. 2.

As shown, the message analysis unit 200 includes: a network/message model generation unit 201; a single message transmission time analysis unit 202; and a message worst-case transmission time analysis unit 203. The network/message model generation unit 201 generates message models classified for each network from the source code of the real-time embedded software or from the design model of the corresponding piece of the real-time embedded software. The single message transmission time analysis unit 202 analyzes a transmission time of each single message based on the message models generated at the network/message model generation unit 201. The message worst-case transmission time analysis unit 203 analyzes a worst-case message transmission time caused by interference between the messages based on the analyzed single message transmission time provided from the single message transmission time analysis unit 202.

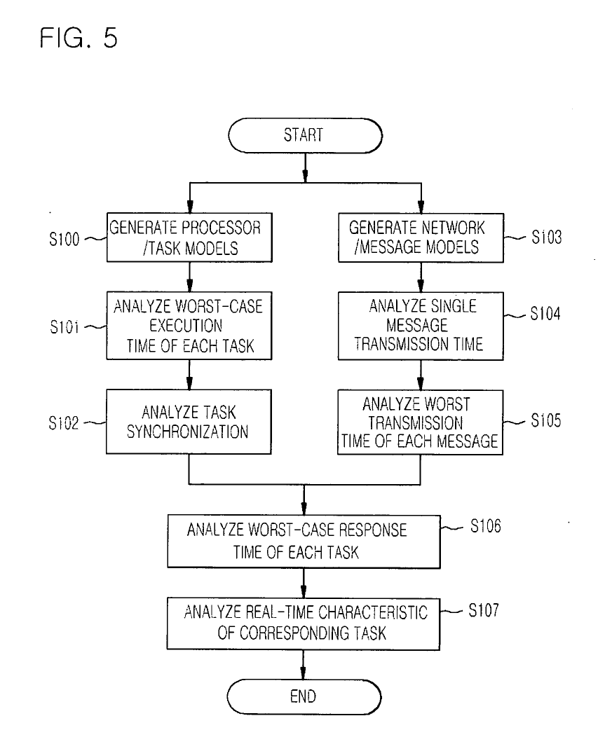

With reference to FIG. 5, operation of the embodied static timing analysis apparatus for distributed real-time embedded software will be described in detail.

In the operation of S100, the processor/task model generation unit 101 of the task analysis unit 100 generates task models classified for each processor from a source code of the real-time embedded software if the source code exists or a design model of a corresponding piece of the real-time embedded software if the source code does not exist.

That is, the embodied static timing analysis method for distributed real-time embedded software can be applied at the designing, implementation, and testing steps during a development of the software. If the static timing analysis method is applied at the implementation and testing steps, since the source code of the real-time embedded software exists, a model for tasks operated at each processor is generated based on the source code. If the static timing analysis method is applied at the designing step, a task model is generated for each processor based on the design model. The task model per processor should be provided with properties including an identifier, a deadline and an execution period. In the case that the tasks are sporadic without having a constant period, the task model for each processor includes a minimum execution interval time instead of the constant period.

In the operation of S101, the task worst-case execution time analysis unit 102 analyzes a worst-case execution time of each task from the task model generated at the processor/task model generation unit 100.

In more detail, if the source code exists, the worst-case execution time analysis unit translates programs in a high-level programming language into ones in an assembly language considering characteristics of a processor where the corresponding real-time embedded software executes. Then, the worst-case execution time during the execution of a single task is analyzed through a processor simulation. If the source code does not exist, the worst-case execution time of each task can be replaced with an estimated value from the software model or with a worst-case execution time of similar tasks whose calculation complexity is similar.

In the operation of S102, the task synchronization analysis unit 103 analyzes a worst-case blocking time of each task, which is caused by synchronization due to a common sharing of the resources between the tasks, based on the task models generated at the processor/task model generation unit 101 and the worst-case execution time of each task analyzed by the task worst-case execution time analysis unit 102.

That is, multiple tasks, which use common resources of system simultaneously at one processor, require synchronization in operation. Hence, a response time of each task is elongated. Especially, the task synchronization analysis unit 103 analyzes how long the individual task is delayed because of the synchronization.

In the operation of S103, the network/message model generation unit 201 of the message analysis unit 200 generates message models classified for each network based on either the source code of the real-time embedded software or the design model of the corresponding piece of the real-time embedded software.

The message model for the individual network should be provided with properties including an identifier, a message length, a deadline, and a transmission period. Also, the individual network is provided with properties such as a network identifier and a network throughput.

In the operation of S104, the single message transmission time analysis unit 202 analyzes a transmission time of each single message from the message models generated by the network/message model generation unit 201.

In particular, the single message transmission time analysis unit 202 analyzes the single message transmission time from the generated network/message models in the absence of interference.

Next, in the operation of S105, the message worst-case transmission time analysis unit 203 analyzes a worst-case message transmission time taking account of the interference between the messages. At this time, the analysis is based on the message models generated by the network/message model generation unit 201 and the single message transmission time analyzed by the single message transmission time analysis unit 202.

That is, the message worst-case transmission time analysis unit 203 analyzes the transmission time of the message that can be interfered maximally with other messages in consideration of the analyzed single message transmission time and a protocol of each network.

In the operation of S106, the task worst-case response time analysis unit 300 analyzes a worst-case response time of each task taken account of a scheduling policy of a corresponding operating system in which said each task is operated. The analysis is carried out based on the task analysis result for each processor from the task analysis unit 100 and the message analysis result for each network from the message analysis unit 200.

Specifically, reflecting the above-described analysis results and the scheduling policy of the operating system in which the individual tasks are operated, the task worst-case response time analysis unit 300 analyzes a maximum response time of one task which can be interfered by the synchronization, the specific scheduling policy of the operating system and the message transmission via network.

In the operation of S107, the task real-time analysis unit 400 analyzes whether the worst-case response time of each task analyzed at the task worst-case response time analysis unit 300 exceeds the deadline of the corresponding task.

The task real-time analysis unit 400 analyzes whether the analyzed worst-case response time of each task exceeds the deadline of the corresponding task and, if the worst-case response times of all the tasks of one distributed real-time embedded software do not exceed the assigned individual deadlines, it is determined that said one distributed real-time embedded software satisfies its real-time requirements. If the real-time requirements are not satisfied, information on the task of which worst-case response time exceeds the deadline is provided.

According to the embodiments of the present invention, there are provided several advantages.

First, the distributed real-time embedded software can be analyzed whether its real-time requirements are satisfied even at the designing step in addition to the implementation and testing steps during a development of the distributed real-time embedded software.

Second, in addition to the single node real-time embedded software operated at one processor, the distributed real-time embedded software including a number of networks and processors can be analyzed as to the satisfaction of the real-time requirements.

Last, the embodied static timing analysis apparatus and method for distributed real-time embedded software is neither the measurement nor testing of the actually implemented system under the limited time and resources but the analysis based on calculation of the response time in the worst-case circumstance confronted as the distributed real-time embedded software is operated. Thus, it is possible to achieve a high level of analysis reliability.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A static timing analysis apparatus for distributed real-time embedded software, comprising:
a task analyzer analyzing tasks per processor based on either a source code of real-time embedded software if the source code exists or a design model of a corresponding piece of the real-time embedded software if the source code does not exist;
a message analyzer analyzing messages per network based on the source code and the design model;
a task worst-case response time analyzer analyzing a worst-case response time of each task, which is taken account of a scheduling policy of a corresponding operating system at which said each task is operated, based on the task analysis result for each processor provided by the task analyzer and the message analysis result for each network provided by the message analyzer; and
a task real-time analyzer analyzing whether the worst-case response time of each task analyzed at the task worst-case response time analyzer exceeds a deadline of the corresponding task.

2. The static timing analysis apparatus of claim 1, wherein the task analyzer includes:
a processor/task model generation unit generating task models classified for each processor based on the source code and the design model;
a task worst-case execution time analysis unit analyzing a worst-case execution time of each task based on the task models generated by the processor/task model generation unit; and
a task synchronization analysis unit analyzing a worst-case response time of each task caused by synchronization due to usage of commonly shared resources between the tasks based on the task models generated by the processor/task model generation unit and the worst-case execution time of each task analyzed by the task worst-case execution time analysis unit.

3. The static timing analysis apparatus of claim 2, wherein the task model for each processor generated by the processor/task model generation unit is a model of various tasks operated in the processor including tasks of a distributed embedded software application program and tasks of an operating system.

4. The static timing analysis apparatus of claim 3, wherein the task model for each processor generated by the processor/task model generation unit is provided with properties including a task identifier, a deadline and an execution period.

5. The static timing analysis apparatus of claim 4, wherein the task model for each processor generated by the processor/task model generation unit is provided with properties including a task identifier, a deadline and a minimum execution interval time if the tasks of the task model are sporadic.

6. The static timing analysis apparatus of claim 1, wherein the message analyzer includes:
a network/message model generation unit generating message models classified for each network based on one of the source code and the design model;
a single message transmission time analysis unit analyzing a transmission time of each single message based on the message models generated by the network/message model generation unit; and
a message worst-case transmission time analysis unit analyzing a worst-case message transmission time caused by interference between the messages based on the message models and the analyzed single message transmission time.

7. The static timing analysis apparatus of claim 6, wherein the message model for each network generated by the network/message model generation unit is provided with properties including a message identifier, a message length, a transmission deadline, and a transmission period.

8. The static timing analysis apparatus of claim 7, wherein said each network is provided with properties including a network identifier and a network throughput.

9. A static timing analysis method for distributed real-time embedded software, comprising the steps of:
analyzing tasks per processor based on either a source code of real-time embedded software if the source code exists or a design model of a corresponding piece of the real-time embedded software if the source code does not exist;
analyzing messages per network based on the source code and the design model;
analyzing a worst-case response time of each task, which is taken account of a scheduling policy of a corresponding operating system at which said each task is operated, based on the task analysis result for each processor and the message analysis result for each network; and
analyzing whether the analyzed worst-case response time of each task exceeds a deadline of the corresponding task.

10. The static timing analysis method of claim 9, wherein the step of analyzing the tasks per processor includes the steps of:
generating task models classified for each processor based on the source code and the design model;
analyzing a worst-case execution time of each task based on the generated task models; and
analyzing a worst-case response time of each task caused by synchronization due to usage of commonly shared resources between the tasks based on the generated task models and the analyzed worst-case execution time of each task.

11. The static timing analysis method of claim 10, wherein the task model for each processor generated at the step of generating the task models classified for each processor is a model of various tasks operated in the processor including tasks of a distributed embedded software application program and tasks of an operating system.

12. The static timing analysis method of claim 11, wherein the task model for each processor generated at the step of generating the task models classified for each processor is provided with properties including a task identifier, a deadline and an execution period.

13. The static timing analysis method of claim 12, wherein the task model for each processor generated at the step of generating the task models classified for each processor is provided with properties including a task identifier, a deadline and a minimum execution interval time if the tasks of the task model are sporadic.

14. The static timing analysis method of claim 9, wherein the step of analyzing the messages per network includes the steps of:
generating message models classified for each network based on one of the source code and the design model;
analyzing a transmission time of each single message based on the message models generated at the step of generating the message model per network; and
analyzing a worst-case message transmission time taking account of interference between the messages based on the generated message models and the analyzed single message transmission time.

15. The static timing analysis method of claim 14, wherein the message model for each network generated at the step of generating the message models classified for each network is provided with properties including a message identifier, a message length, a deadline, and a transmission period.

16. The static timing analysis method of claim 15, wherein said each network is provided with properties including a network identifier and a network throughput.
